(19) United States
(12) Patent Application Publication
(10) Pub. No.: US 2012/0071320 A1
(43) Pub. Date: Mar. 22, 2012

(54) LIQUID AGRICULTURAL FORMULATIONS OF IMPROVED STABILITY

(75) Inventors: John M. Atkinson, Zionsville, IN (US); Lei Liu, Carmel, IN (US); Melissa G. Olds, Zionsville, IN (US); Franklin N. Keeney, Carmel, IN (US)

(73) Assignee: DOW AGROSCIENCES LLC, Indianapolis, IN (US)

(21) Appl. No.: 13/234,204

(22) Filed: Sep. 16, 2011

Related U.S. Application Data
(60) Provisional application No. 61/383,888, filed on Sep. 17, 2010.

(51) Int. Cl. A01N 25/32; A01N 43/90; A01P 13/00; A01N 43/40; A01N 31/00; A01N 37/10; A01N 43/66; A01N 43/54

(52) U.S. Cl. 504/103; 504/230; 504/241; 504/239; 504/260; 504/354; 504/324

(57) ABSTRACT

Agricultural oil dispersions of improved stability and processes to make and methods to use such compositions are disclosed. The compositions are comprised of an active ingredient coated with one or more non-oil soluble polymers that hinder degradation of the active ingredient by other ingredients.

### CROSS REFERENCE TO RELATED APPLICATIONS

This application claims the benefit of U.S. Provisional Patent Application Ser. No. 61/383,888 filed Sep. 17, 2010.

### FIELD OF THE INVENTION

The present invention concerns liquid agricultural compositions of improved stability and processes to make such compositions. The compositions contain active ingredients coated with one or more polymers that hinder their interaction with and degradation by other ingredients. The novel compositions have improved storage stability compared to compositions containing uncoated active ingredients.

### BACKGROUND OF THE INVENTION

In the design of an agricultural formulation product, an important issue to be considered is its stability. Failure to meet a set of stability requirements which usually depend on the specific market, application and regulations will certainly lead to failure in its commercialization. There are many causes of formulation instabilities, such as a) chemical instabilities due to reactions between ingredients (actives and/or inerts, etc.), photo-degradations, and oxidations, etc., b) physical instabilities due to phase separations (Oswald ripening, crystallization, sedimentations, creamings, etc.) and c) environmental factors (temperature, humidity/moisture, etc.). In today's agrochemical market, it has become increasingly common to design formulations that contain multiple active ingredients and their required solvents, safeners, and/or adjuvants, etc., in order to achieve the optimal spectrum, efficacy, and delivery efficiency, which consequently makes formulation stability more and more challenging. Therefore, technologies that can effectively isolate, hinder, or eliminate, adverse reactions or interactions between incompatible ingredients are often critical for a successful product.

Flowable or liquid formulations are among the most common formulation types for many agricultural products and are generally preferred by customers due to their ease of handling in measuring, pumping, diluting, and spraying operations. Liquid formulations include emulsifiable concentrates (EC), suspension concentrates (SC), soluble liquids (SL), liquid flowables (F) and oil dispersions (OD) where one or more active ingredients may be dissolved in or suspended in the liquid media of the formulation.

Oil dispersions are a relatively recent formulation innovation that are seeing increasing use in today's agrochemical products. The basic components of an oil dispersion are the solvent or oil phase and the dispersed solid phase. These basic components may include soluble and insoluble active ingredients, petroleum or naturally derived solvents, safeners, rheology additives, emulsifiers, dispersants and other co-formulants that help deliver the desired attributes of the product. Oil dispersion formulations are very suitable for the following scenarios: (1) water sensitive active ingredients which may be susceptible to degradation by hydrolysis, 2) compatibility issues with active ingredient mixtures, and 3) the need for build-in adjuvancy.

Formulations of the sulfonylurea class of herbicides can sometimes present challenges due to their inherent chemical instability. It is well known that some members of this class have a tendency to hydrolyze via cleavage at the sulfonylurea bridge in acidic or alkaline pH environments. This instability is sometimes considered favorable in terms of achieving low soil residues of these products, but can present challenges related to storage stability of the formulated products. The hydrolysis of thifensulfuron methyl has been described by J. -P. Cambon and J. Bastide in, “Hydrolysis Kinetics of Thifensulfuron Methyl in Aqueous Buffer Solutions,” J. Agric. Food Chem., 44, pg. 333-337 (1996), and was found to be relatively fast under both acidic and basic conditions. Because of this chemical property, thifensulfuron methyl has been found to be particularly unstable in liquid agricultural formulations.

Some sulfonylurea herbicides are also prone to degradation due to chemical incompatibilities with other active ingredients in the formulation. This can make developing formulations of sulfonylurea herbicides containing additional active ingredients rather challenging. Efforts to stabilize solid particle formulations containing sulfonylurea herbicides and other active ingredients by adding a hydrophobic coating to the sulfonylurea herbicide have recently been disclosed, for example, see U.S. Pat. No. 6,015,773 and WO 2009/113093. However, there is a continuing need for improved methods for preparing stable liquid formulations containing unstable active ingredients, such as sulfonylurea herbicides, either alone or in combination with other active ingredients.

The present invention provides improved compositions and methods for the preparation of liquid formulations of improved stability containing active ingredients prone to chemical degradation, optionally containing additional active ingredients.

### SUMMARY OF THE INVENTION

The present invention concerns oil dispersions of improved stability which comprise:

a) an oil phase comprising, with respect to the total composition, from about 200 grams per liter (g/L) to about 999 g/L of a water immiscible solvent; and

b) a dispersed active ingredient with a non-oil soluble polymer coating comprising, with respect to the total composition, from about 1 g/L to about 700 g/L

Another aspect of the present invention concerns a method of preparing the oil dispersion of improved stability by coating the active ingredient with the non-oil soluble polymer and then dispersing the polymer coated active ingredient in the oil phase.

An additional aspect of the present invention concerns the addition of at least one additional uncoated active ingredient or safener to the composition.

### DETAILED DESCRIPTION OF THE INVENTION

This invention provides oil dispersions of improved stability, comprised of an oil phase, a dispersed active ingredient coated with a non-oil soluble polymer and optionally any other inert formulation ingredients.

A dispersed active ingredient may be stable or unstable in a particular oil dispersion formulation depending on the chemical nature of the dispersed active ingredient and the composition of the oil dispersion. The dispersed active ingredient in an oil dispersion of the present invention that is prone to chemical instability and degradation during storage may be stabilized by the addition of a non-oil soluble polymer coating to it. Such a polymer coating on the surface of the dispersed active ingredient may hinder or prevent contact with other active ingredients or co-formulant ingredients of the composition and degradation may be slowed or prevented. This degradation may, for example, be caused by the hydrolysis of the dispersed active ingredient because it is very sensitive to water or by reactions of the dispersed active ingredient with incompatible active ingredients or co-formulant ingredients that are also present in the composition. Additionally, a polymer coated dispersed active ingredient of the present invention may be less prone to Ostwald Ripening or crystal growth because of limited contact with the solvent which can, if not prevented, lead to formulation instability or unsuitability for agricultural spray applications because of nozzle clogging.

Polymer coating in the present invention is defined as the deposition of a polymer or mixture of polymers onto the surface of the dispersed active ingredient particles that may partially or totally surround the particles of the dispersed active ingredient. The polymer coating may form a barrier or protective surface layer that inhibits or prevents contact of the dispersed active ingredient with other active or co-formulant ingredients that may cause chemical degradation of the dispersed active ingredient or physical instability to the formulation. The polymer or mixture of polymers used to form the polymer coating has less than 1000 parts per million (ppm) solubility in the oil phase of the oil dispersion.

The polymer coating of the present invention may comprise one or more natural or man-made polymers and co-polymers, derivatives and mixtures thereof. Suitable polymers and co-polymers may include polyvinyl alcohols, polyvinyl acetates, polyvinyl pyrrolidones, polyacrylic acid and esters, polymethacrylic acid and esters, and mixtures thereof, also latexes, lignosulfonates, polysaccharides, modified polysaccharides, proteins and mixtures and derivatives thereof. Suitable polymer coatings generally have less than 1000 ppm solubility in the oil phase of the inventive composition.

Examples of polymers and co-polymers used as polymer coatings of the present invention include, but are not limited to, polyvinyl alcohol resins such as Gohsenol GL03, Gohsenol® GL05 (Gohsenol is registered trademark of Nippon Gohsei), Celvol® 165 and Celvol® 540 (Celvol is registered trademark of Sekisui Specialty Chemicals America LLC) and co-polymers of polyvinyl alcohol such as Ultiloc 4007 (product of Sekisui Specialty Chemicals America LLC) which is a co-polymer of 2-propenoic acid methyl ester and hydrolyzed ethenyl acetate and has a Chemical Abstracts Registry number of 654647-80-0; polyvinylpyrrolidone resins such as Agrimer® 30 and co-polymers of polyvinylpyrrolidone with vinyl acetate such as Agrimer® VA3, Agrimer® VA6 and Agrimer® VA7 (Agrimer is registered trademark of International Specialty Products); latexes such as acrylic, vinylacrylic, methacrylic, vinylmethacrylic and styrene-butadiene latexes wherein the acrylic- and methacrylic-containing latexes comprise ester groups derived from C₁-C₂₀ alcohols such as UCAR® 379G (UCAR is a registered trademark of Arkema Inc); also polysaccharides such as chitosan, and alginate; modified polysaccharides such as alkylated celluloses like Methocel®, Ethocel® (Methocel and Ethocel are registered trademarks of The Dow Chemical Company) and the like; and modified starches.

The polymer coating of the present invention may comprise, with respect to the dispersed active ingredient of the present invention, from about 0.1 wt % to about 20 wt %, preferably from about 0.5 wt % to about 10 wt %.

The oil phase of the present invention is generally comprised of an organic, water immiscible solvent and may comprise one or more of petroleum distillates such as aromatic hydrocarbons derived from benzene, such as toluene, xylenes, other alkylated benzenes and the like, and naphthalene derivatives, aliphatic hydrocarbons such as hexane, octane, cyclohexane, and the like, mineral oils from the aliphatic or isoparaffinic series, and mixtures of aromatic and aliphatic hydrocarbons; halogenated aromatic or aliphatic hydrocarbons; vegetable, seed or animal oils such as soybean oil, rape seed oil, olive oil, castor oil, sunflower seed oil, coconut oil, corn oil, cotton seed oil, linseed oil, palm oil, peanut oil, safflower oil, sesame oil, tung oil and the like, and C₁-C₆ mono-esters derived from vegetable, seed or animal oils; dialkyl amides of short and long chain, saturated and unsaturated carboxylic acids; C₁-C₁₂ esters of aromatic carboxylic acids and dicarboxylic acids, and C₁-C₁₂ esters of aliphatic and cyclo-aliphatic carboxylic acids.

The oil phase of the present invention may comprise, with respect to the total composition, from about 200 g/L to 999 g/L, preferably from about 300 g/L to 950 g/L.

The dispersed active ingredients of the present invention with a polymer coating may include the agrochemical active ingredient classes of insecticides, herbicides and fungicides. Suitable active ingredients from these classes have less than 1000 ppm solubility in the oil phase and may exhibit chemical or physical instability in a particular oil dispersion composition. These instabilities may adversely impact product storage stability and render the product as unsuitable for agricultural spray applications.

Suitable dispersed herbicides of the present invention with a polymer coating may include, for example, members of the sulfonylurea and sulfonamide classes of herbicides such as, but not limited to thifensulfuron methyl, metsulfuron methyl, rimsulfuron, tribenuron methyl, bensulfuron methyl, chlorimuron ethyl, azimsulfuron, pyroxsulam, penoxsulam, florasulam, chloransulam methyl, diclosulam and metosulam.

For an oil dispersion formulation of the present invention the dispersible herbicides with a polymer coating may comprise, with respect to the total composition, from about 1 g/L to about 700 g/L, preferably from about 1 g/L to about 500 g/L. It is commonly known that this concentrated formulation may be diluted from 1 to 2000 fold at point of use depending on the agricultural practices.

The composition of the present invention may optionally include active ingredients and safeners that do not have a polymer coating and can be either dispersed or dissolved in the oil phase. These active ingredients and safeners may include the agrochemical active ingredient classes of insecticides, herbicides and fungicides, and herbicide safeners.

Suitable active ingredients of the present invention that do not have a polymer coating and may be dispersed in the oil phase may, provided they are chemically and physically stable in the particular composition and have less than 1000 ppm solubility in the oil phase, include one or more herbicides from, but not limited to, the classes of sulfonamides, sulfonylureas, arylpyridine carboxylic acids, arylpyrimidine carboxylic acids, hydroxybenzonitriles, anilides, imidazolinones, carbazones and derivatives thereof; also, the free acids, alkali metal salts or amine salts of the herbicide classes of benzoic acids, phenoxyalkanoic acids, pyridinecarboxylic acids, pyridyloxycarboxylic acids, pyrimidinecarboxylic acids and hydroxybenzonitriles herbicides.

Herbicides which may be suitable for dispersion in the oil phase of the present invention that do not have a polymer coating are, provided they are chemically and physically stable in the particular composition and have less than about 1000 ppm solubility in the oil phase, triasulfuron, tribenuron, metasulfuron, thifensulfuron, flupyrsulfuron, iodosulfuron, rimsulfuron, nicosulfuron, cinosulfuron, bensulfuron, trifloxysulfuron, foramsulphuron, mesosulphuron, sulphosulphuron, tritosulphuron, furthermore flumetsulam, metosulam, chloransulam, florasulam, diclosulam, penoxsulam, pyroxsulam, diflufenican, imazethabenz, imazethapyr, imazaquin, imazamox, flucarbazone, propoxycarbazone, amicarbazone, or compounds of the following formula

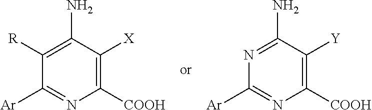

wherein

Ar represents a phenyl group substituted with one to four substituents independently selected from halogen, C₁-C₆ alkyl, C₁-C₆ alkoxy, C₂-C₄ alkoxyalkyl, C₂-C₆ alkylcarbonyl, C₁-C₆ alkylthio, C₁-C₆ haloalkyl, C₁-C₆ haloalkoxy, C₂-C₄ haloalkoxyalkyl, C₂-C₆ haloalkylcarbonyl, C₁-C₆ haloalkylthio, —OCH₂CH₂—, —OCH₂CH₂CH₂—, —OCH₂O—, or —OCH₂CH₂O—;
R represents H or F;
X represents Cl or vinyl; and
Y represents Cl, vinyl or methoxy;
   and their salts and esters as disclosed, for example, in U.S. Pat. No. 7,314,849 B2, U.S. Pat. No. 7,300,907 B2, U.S. Pat. No. 7,786,044 B2 and U.S. Pat. No. 7,642,220 B2. An especially suitable herbicide of this class is the compound

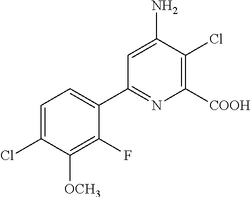

and its C₁-C₆ alkyl esters or salt derivatives such as, for example, the methyl ester.

Additional herbicides which may be suitable for dispersion in the oil phase of the present invention that do not have a polymer coating are, provided they are chemically and physically stable in the particular composition and have less than 1000 ppm solubility in the oil phase, the free acids, alkali metal salts or amine salts of aminocyclopyrachlor, dicamba, 2,4-D, MCPA, 2,4-DB, aminopyralid, picloram, clopyralid, fluroxypyr and triclopyr, and the alkali metal salts of bromoxynil and ioxynil. The amine salts may include primary, secondary, tertiary or quaternary alkylamines, alkanolamines, alkylalkanolamines or alkoxyalkanolamines wherein the alkyl and alkanol groups are saturated and contain C₁-C₄ alkyl groups individually. The alkali metal salts may include sodium and potassium.

For an oil dispersion formulation of the present invention the oil dispersible herbicides that do not have a polymer coating may comprise, with respect to the total composition, from about 1 g/L to about 700 g/L, preferably from about 1 g/L to about 500 g/L. It is commonly known that this concentrated formulation may be diluted from 1 to 2000 fold at point of use depending on the agricultural practices.

Suitable active ingredients of the present invention that do not have a polymer coating and may be soluble in the oil phase include one or more herbicides, insecticides or fungicides, but are not limited to, esters of carboxylate, phosphate, or sulfate pesticides. These oil soluble active ingredients may include benzoic acid herbicides such as dicamba esters, phenoxyalkanoic acid herbicides such as 2,4-D, MCPA and 2,4-DB esters, aryloxyphenoxypropionic acid herbicides such as clodinafop, cyhalofop, fenoxaprop, fluazifop, haloxyfop and quizalofop esters, pyridinecarboxylic acid herbicides such as aminopyralid, picloram and clopyralid esters, pyridyloxyalkanoic acid herbicides such as fluroxypyr and triclopyr esters, hydroxybenzonitrile herbicides such as bromoxynil and ioxynil esters, insecticides such as chlorpyrifos and chlorpyrifos-methyl, and fungicides such as dinocap, kresoxim-methyl, and the like.

Additional ingredients of the present invention that may be soluble in the oil phase may include one or more herbicide safeners. Suitable herbicide safeners of the present invention may comprise, but are not limited to, cloquintocet mexyl, benoxacor, cyometrinil, cyprosulfamide, dichlormid, dicyclonon, dietholate, fenchlorazole ethyl, fenclorim, flurazole, fluxofenim, furilazole, isoxadifen ethyl, mefenpyr diethyl, mephenate, naphthalic anhydride, oxabetrinil and derivatives and analogs thereof.

The optional oil soluble active ingredients and herbicide safeners of the present invention may comprise, with respect to the total composition, from about 1 g/L to about 700 g/L, preferably from about 1 g/L to about 500 g/L. It is commonly known that this concentrated formulation may be diluted from 1 to 2000 fold at point of use depending on the agricultural practices.

The composition of the present disclosure may optionally include one or more additional co-formulant ingredients such as emulsifying agents, dispersing agents, wetting agents, thickening or rheology aids, antifoam agents, adjuvants, stabilizers, solvents, fragrants, sequestering agents, neutralizing agents, buffers, corrosion inhibitors, dyes, odorants and other commonly used ingredients.

It is usually desirable to incorporate one or more surface-active agents into the compositions of the present invention. The surface-active agents can be anionic, cationic or nonionic in character and can be employed as emulsifying agents, dispersing agents, wetting agents, suspending agents, or for other purposes. Surfactants conventionally used in the art of formulation and which may also be used in the present formulations are described, inter alia, in “McCutcheon's Detergents and Emulsifiers Annual”, MC Publishing Corp., Ridgewood, N.J., 1998 and in “Encyclopedia of Surfactants”, Vol. I-III, Chemical publishing Co., New York, 1980-81. Typical surface-active agents include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable oils such as soy bean oil, rape seed oil, olive oil, castor oil, sunflower seed oil, coconut oil, corn oil, cotton seed oil, linseed oil, palm oil, peanut oil, safflower oil, sesame oil, tung oil and the like; and esters of the above vegetable oils.

Oftentimes, some of these materials, such as vegetable or seed oils and their esters, can be used interchangeably as an agricultural adjuvant, as a liquid carrier or as a surface active agent.

In a typical procedure for preparing the oil dispersion of the present invention, the dispersed active ingredient is air milled to a desirable size range (e.g. 0.1-10 μm, preferably 0.5-5 μm) and is then pre-dispersed in an aqueous solution with the help of wetting agents and dispersants. The aqueous dispersion is then treated with the polymer, homogenized until well mixed and then spray dried. The polymer coated dispersed active ingredient is then added as a dry powder with mixing to the oil phase containing the solvent, and optionally other ingredients such as dispersants, emulsifiers, wetting agents, thickening agents, and other dispersed or dissolved active ingredients or safeners, that had previously been prepared, until a well mixed dispersion is obtained.

An example of an oil dispersion formulation of the present invention in which degradation of the dispersed active ingredient is retarded by the polymer coating comprises:
a) a solvent comprising, with respect to the total composition, from about 200 g/L to about 950 g/L of Edenor ME C₁₂-C₁₈;
b) thifensulfuron methyl coated with a polyvinyl alcohol comprising, with respect to the total composition, from about 1 g/L to about 500 g/L;
c) clopyralid ethanolamine comprising, with respect to the total composition, from about 25 g/L to about 500 g/L;
d) fluroxypyr methylheptyl ester comprising, with respect to the total composition, from about 25 g/L to about 500 g/L; and
e) optionally, other inert formulation ingredients.
   Edenor ME C₁₂-C₁₈ is a mixture of C₁₂-C₁₈ fatty acid methyl esters (Cognis).

Another aspect of the present invention concerns a method of preparing the oil dispersion of improved stability comprising:

a) milling the active ingredient to be coated and pre-dispersing it in an aqueous solution with the help of wetting agents and dispersants;

b) adding one or more non-oil soluble coating polymers to the dispersion in a);

c) removing water from the dispersion obtained in b) to provide a dry solid; and

d) dispersing the dry solid from c) with mixing in an oil phase containing the solvent and optionally other inert ingredients, active ingredients or safeners.

A further aspect of the present invention concerns a method of using the oil dispersion of improved stability and optionally diluting it in an aqueous spray mixture for agricultural applications such as with an aqueous dispersed herbicide with a polymer coating for weed management.

The effective amount of the oil dispersion formulation of the present invention to be employed in a typical agricultural application often depends upon, for example, the type of plants, the stage of growth of the plant, severity of environmental conditions, the weeds, insects or fungal pathogens to be controlled and application conditions. Typically, a plant in need of protection from weeds or insects, or disease pathogen control or elimination, is contacted with an amount of the oil dispersion formulation diluted in a carrier such as water that will provide an amount from about 1 to about 40,000 ppm, preferably from about 10 to about 20,000 ppm of the active ingredient. The contacting may be in any effective manner. For example, any exposed part of the plant, e.g., leaves or stems may be sprayed with the active ingredient in mixture with a suitable amount of a diluent or carrier such as water.

The aforementioned compositions of the present invention may be applied to the plant foliage or the soil or area adjacent to the plant. Additionally, the compositions of the present invention may be mixed with or applied with any combination of agricultural active ingredients such as arthropodicides, bacteriocides, biocides, fungicides, growth regulators, herbicides, insecticides, miticides, molluscides, nematocides, pheromones and rodenticides.

In addition to the compositions and uses set forth above, the present invention also embraces the composition and use of these oil dispersions in combination with one or more additional compatible ingredients. Other additional ingredients may include, for example, one or more other pesticides, dyes, fertilizers and any other additional ingredients providing functional utility, such as, for example, stabilizers, fragrants, viscosity-modifying additives, suspension aids, dispersants and freeze-point depressants.

The following examples illustrate the present invention.

### EXAMPLE 1

### Preparation of Polymer Coated Thifensulfuron Methyl Samples

The following general procedure was used for preparing samples of polymer coated thifensulfuron methyl with the ingredients and quantities listed in Table 1. Thifensulfuron methyl technical was air milled to an average particle size of 2.0-3.0 μm (d(0.5)) and then added to an aqueous solution consisting of Pluronic® P-105, Morwet® D-425 and Celvol® 165 (coating polymer) in 80 milliliter (mL) of water. These materials were mixed at

TABLE 1
Ingredients Used to Prepare Polymer
Coated Thifensulfuron Methyl

| | Total Wt. % | |
|---|---|---|
| Material | (dry wt basis) | Total Weight (g) |
| 20% Pluronic ® P- | 3.0 | 3.75 |
| 105¹ | | |
| Morwet ® D-425² | 2.0 | 0.50 |
| 3% Celvol ® 165³ | 5.0 | 41.67 |
| thifensulfuron | 90.0 | 22.50 |
| methyl | | |
| water | | 36.58 |

¹Pluronic ® P-105 is an EO-PO block co-polymer dispersant with an average molecular weight (mw) of 6500;
²Morwet ® D-425 ™ is a sodium naphthalene sulfonate condensate wetting agent/dispersant;
Celvol ® 165 is a >99% hydrolyzed polyvinyl alcohol with a viscosity in water (4 wt %; at 20° C.) of 62-72 centipoises that serves as the coating polymer; Pluronic, Morwet and Celvol are trademarks of BASF, AkzoNobel and Sekisui Specialty Chemicals America LLC, respectively.

2000 rpm using an IKA Euro Star 6000 mixer with a dispersing blade. Once all of the materials had been well dispersed, the mixture were transferred to a Silverson homogenizer and homogenized at 6000 rpm for a period of 20 min. The homogenized mixture was then spray dried on a Buchi Model B-290 spray dryer using the following conditions: inlet temperature 160° C., outlet temperature 93° C., air nozzle pressure of 40-45 bar (4,000-4,500 kilopascal), aspiration rate of 100% and a liquid feed rate of 400 mL/hr. Once the entire sample had been spray dried, the instrument was allowed to cool to room temperature and the sample in the cyclone collector was removed and the particle size was measured and generally found to range from about 2 μm to about 6 μm (d(0.5)).

### EXAMPLE 2

### Formulation of Polymer Coated Thifensulfuron Methyl Samples as Oil Dispersions

Oil dispersions containing polymer coated thifensulfuron methyl were prepared using the compositions listed in Table 2. All ingredients, with the exception of the sprayed dried, polymer coated thifensulfuron methyl, were combined and mixed with a mechanical mixer. The mixture was then bead milled by passing it one time through an Eiger mill containing 1.0-1.25 mm glass beads. The polymer coated or uncoated (control sample) thifensulfuron methyl was then added to the bead milled mixture and the resulting mixture was stirred at low shear with a mechanical mixer until homogenous. Table 3 lists the samples prepared in this manner.

TABLE 2
Ingredients Used in the Preparation of Oil Dispersions
Containing Polymer Coated Thifensulfuron Methyl

| | Amounts |
|---|---|
| Ingredients | (wt %) |
| clopyralid-ethanolamine | 12.5 |
| fluroxypyr-methylheptyl ester | 13.3 |
| thifensulfuron-methyl (coated or uncoated) | 0.46 |
| Tensiofix ™ N9824HF—surfactant¹ | 9.0 |
| Atlox ™ 4912—surfactant² | 1.0 |
| Aerosil ® R974—thickener³ | 3.05 |
| Agnique ME C12-C18⁴ | 60.69 |
| Total | 100.0 |

¹Tensiofix ™ N9824HF is a proprietary surfactant blend supplied by OmniChem;
²Atlox 4912 is a ABA block co-polymer surfactant with an HLB value of 6 and a mw of about 5000;
³Aerosil ® R974 is a hydrophobic fumed silica thickening agent;
⁴Agnique ME C12-C18 is a mixture of C₁₂-C₁₈ fatty acid methyl esters (Cognis); Tensiofix, Atlox and Aerosil are trademarks of OmniChem, Croda, and Evonik, respectively.

### EXAMPLE 3

### Evaluation of Oil Dispersion Formulations of Polymer Coated Thifensulfuron Methyl Samples for Chemical Degradation

The samples prepared as described in Example 2 were evaluated for the chemical degradation of thifensulfuron methyl after storage at 54° C. for two weeks. The data for 7 samples containing polymer coated thifensulfuron methyl and one control sample containing uncoated thifensulfuron methyl are shown in Table 3. Upon inspection of the data shown in Table 3, all 7 samples containing thifensulfuron methyl coated with a variety of polymers showed improved chemical stability as compared to the uncoated control sample, as determined by the relatively smaller loss of thifensulfuron methyl as indicated by a chemical analysis of each.

TABLE 3
Chemical Stability of Polymer Coated Thifensulfuron
Methyl in Oil Dispersion Formulations after
2 Weeks Storage @ 54° C.

| | | | Polymer | Wt % Loss of |
|---|---|---|---|---|
| | Polymer | Polymer | Coating | Thifensulfuron |
| Sample | coating¹ | description² | Wt % | Me |
| 1 | UltiLoc 4007 | Co-polymer of | 5.0% | 32.2 |
| | | PVA | | |
| 2 | Celvol ® 165 | PVA | 5.0% | 44.5 |
| 3 | Agrimer ® 30 | PVP | 5.0% | 56.3 |
| 4 | UCAR ® | Vinyl-acrylic | 5.0% | 65.9 |
| | 379G | latex | | |
| 5 | Agrimer ® | PVP/PVAc co- | 5.0% | 63.8 |
| | VA6 | polymer | | |
| 6 | Agrimer ® VA | PVP/PVAc co- | 5.0% | 68.1 |
| | 3I | polymer | | |
| 7 | chitosan | polysaccharide | 5.0% | 78.7 |
| Control | uncoated | | 0.0% | 81.5 |

¹UltiLoc 4007 was obtained from Sekisui Specialty Chemicals America LLC; Celvol is a registered trademark of Sekisui Specialty Chemicals America LLC; Agrimer is a registered trademark of International Specialty Products; UCAR is a registered trademark of Arkema Inc.
²PVA = polyvinyl alcohol, PVP = polyvinylpyrrolidone, PVAc = polyvinyl acetate

What is claimed:

1. An oil dispersion of improved stability which comprises:
a) an oil phase comprising, with respect to the total composition, from about 200 g/L to about 999 g/L of a non-water miscible solvent; and
b) a dispersed active ingredient with a non-oil soluble polymer coating comprising, with respect to the total composition, from about 1 g/L to about 700 g/L.

2. The composition of claim 1 wherein the dispersed active ingredient with a non-oil soluble polymer coating is an insecticide, a herbicide or a fungicide.

3. The composition of claim 2 wherein the herbicide with the non-oil soluble coating is thifensulfuron methyl, metsulfuron methyl, rimsulfuron, tribenuron methyl, bensulfuron methyl, chlorimuron ethyl, azimsulfuron, pyroxsulam, penoxsulam, florasulam, chloransulam methyl, diclosulam, metosulam or mixtures thereof.

4. The composition of claim 1 wherein the polymer coating is a natural or a man-made polymer, or co-polymers, derivatives or mixtures thereof.

5. The composition of claim 4 wherein the man-made polymer is a polyvinyl alcohol, a polyvinyl acetate, a polyvinyl pyrrolidone, a poly(methyl acrylate), a poly(acrylic acid) or co-polymers, derivatives or mixtures thereof.

6. The composition of claim 1 further comprising a non-polymer coated insecticide, herbicide, fungicide or herbicide safener.

7. The composition of claim 6 wherein the non-polymer coated herbicide is a free acid alkali metal salt or amine salt of 2,4-D, 2,4-DB, aminocyclopyrachlor, aminopyralid, bromoxynil, clopyralid, dicamba, fluroxypyr, ioxynil, MCPA, picloram, triclopyr or mixtures thereof.

8. The composition of claim 6 wherein the non-polymer coated herbicide is triasulfuron, tribenuron, metasulfuron, thifensulfuron, flupyrsulfuron, iodosulfuron, rimsulfuron, nicosulfuron, cinosulfuron, bensulfuron, trifloxysulfuron, foramsulphuron, mesosulphuron, sulphosulphuron, tritosulphuron, furthermore flumetsulam, metosulam, chloransulam, florasulam, diclosulam, penoxsulam, pyroxsulam, diflufenican, imazethabenz, imazethapyr, imazaquin, imazamox, flucarbazone, propoxycarbazone, amicarbazone or compounds of the formula 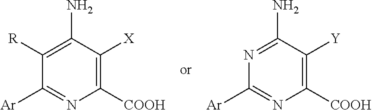
wherein
Ar represents a phenyl group substituted with one to four substituents independently selected from halogen, C₁-C₆ alkyl, Cᵢ-C₆ alkoxy, C₂-C₄ alkoxyalkyl, C₂-C₆ alkylcarbonyl, C₁-C₆ alkylthio, C₁-C₆ haloalkyl, C₁-C₆ haloalkoxy, C₂-C₄ haloalkoxyalkyl, C₂-C₆ haloalkylcarbonyl, C₁-C₆ haloalkylthio, —OCH₂CH₂—, —OCH₂CH₂CH₂—, —OCH₂O—, or —OCH₂CH₂O—;
R represents H or F;
X represents Cl or vinyl; and
Y represents Cl, vinyl or methoxy;
and their salts and esters.

9. The composition of claim 6 wherein the non-polymer coated herbicide is an ester of carboxylate, phosphate or sulfate pesticide.

10. A method of preparing the composition of claim 1 which comprises:
a) milling the active ingredient to be coated and pre-dispersing it in an aqueous solution with the help of wetting agents and dispersants;
b) adding one or more non-oil soluble coating polymers to the dispersion in a);
c) removing water from the dispersion obtained in b) to provide a dry solid; and
d) dispersing the dry solid from c) with mixing in an oil phase containing the solvent and optionally other inert ingredients, active ingredients or safeners.
